(19) United States
(12) Patent Application Publication
(10) Pub. No.: US 2012/0019425 A1
(43) Pub. Date: Jan. 26, 2012

(54) Antenna For Increasing Beamwidth Of An Antenna Radiation Pattern

(76) Inventors: Kwan-ho LEE, Ann Arbor, MI (US); Wladimiro VILLARROEL, Ypsilanti, MI (US); Yasutaka HORIKI, Ypsilanti, MI (US); Ming LEE, Ypsilanti, OH (US)

(21) Appl. No.: 12/840,517

(22) Filed: Jul. 21, 2010

(51) Int. Cl. H01Q 1/38; H01Q 1/00; H01Q 21/26

(52) U.S. Cl. 343/797; 343/700 MS; 343/720

(57) ABSTRACT

An antenna includes a ground plane, a dielectric, and an active radiating element. The dielectric is disposed on the ground plane, and the active radiating element is embedded in the dielectric for transmitting and/or receiving an RF signal. The antenna also includes a feeding element and a passive radiating element. The feeding element extends into the dielectric and is electrically coupled to the active radiating element. The passive radiating element is disposed on the ground plane and surrounds a periphery of the dielectric for perturbating the RF signal. The ground plane has a plurality of edges. At least one of the edges extends as a curvilinear lip. The curvilinear lip extends in a direction opposite the passive radiating element for directing the RF signal and for preventing abrupt discontinuity of the RF signal.

### BACKGROUND OF THE INVENTION

1. Field of the Invention

The subject invention generally relates to an antenna which increases a beamwidth of an antenna radiation pattern. More specifically, the antenna of this invention achieves the increased beamwidth of the antenna radiation pattern with a ground plane having at least one edge which extends as a curvilinear lip, and with a passive radiating element.

2. Description of Related Art

Antennas for receiving radio frequency (RF) signals are known in the art. One example of such an antenna is disclosed in PCT Publication No. WO 02/069445 (the '445 publication). The '455 publication discloses an antenna array having a ground plane and a plurality of antenna elements on the ground plane. The ground plane includes a flat portion and a pair of rolled portions. The rolled portions extend from opposing ends of the flat portion of the ground plane to function as an “infinite” ground plane. The antenna array of the '455 publication operates in an ultra wide band frequency for impulse radar applications. Particularly, the antenna array of the '455 publication is utilized for surveillance monitoring through walls. The construct of the antenna array of the '455 publication is not ideal for transmission and/or reception of circularly polarized RF signals. Therefore, this antenna array is not appropriate for Satellite Digital Audio Radio Service (SDARS) applications, and there is a need for an improved antenna.

### SUMMARY OF THE INVENTION AND ADVANTAGES

The invention provides an antenna comprising a ground plane, a dielectric, an active radiating element, a feeding element, and a passive radiating element. The dielectric is disposed on the ground plane, and the active radiating element is embedded in the dielectric for transmitting and/or receiving an RF signal. The feeding element extends into the dielectric and is electrically coupled to the active radiating element. The passive radiating element is disposed on the ground plane and surrounds a periphery of the dielectric. The passive radiating element perturbates the RF signal. The ground plane has a plurality of edges. At least one of the edges extends as a curvilinear lip in a direction opposite the passive radiating element. The edge or edges which extend as a curvilinear lip direct the RF signal and prevent abrupt discontinuity of the RF signal.

The RF signal follows the curvilinear lip of the ground plane thereby preventing the abrupt discontinuity of the RF signal and reducing undesired diffraction effects which would, ultimately, have an impact on a beamwidth of an antenna radiation pattern of the antenna. As such, the edges of the ground plane, at least one of which extends as a curvilinear lip, enable this antenna to improve reception characteristics of an SDARS signal at low elevation angles, generally those ranging from 10° to 30° and from 150° to 170°. Additionally, the passive radiating element which, as described above, perturbates the RF signal, acts in conjunction with the edge of the ground plane to further improve the beamwidth the antenna radiation pattern.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a perspective view of a vehicle with a preferred embodiment of an antenna integrated with a nonconductive pane;

FIG. 2A is a perspective view of the preferred embodiment of the antenna illustrating a ground plane with four edges extending as a curvilinear lip, a dielectric, a plurality of active radiating elements in a cross dipole configuration, and a passive radiating element surrounding the dielectric;

FIG. 2B is a side view of the preferred embodiment of the antenna of FIG. 2A;

FIG. 2C is a top view of the preferred embodiment of the antenna of FIG. 2A;

FIG. 2D is a partial cross-sectional view of the preferred embodiment of the antenna taken along line 2D-2D of FIG. 2C where a portion of the ground plane is cut away illustrating a power divider mounted to an underside of the ground plane and electrically coupled with the feeding element;

FIG. 3A is a partial cut-away perspective view of the preferred embodiment of the antenna of FIG. 2A integrated with the nonconductive pane;

FIG. 3B is a partial cut-away perspective view of an alternative embodiment of the antenna integrated with the nonconductive pane, where the passive radiating element is rectangular in shape surrounding the dielectric which is also rectangular in shape;

FIG. 4A is a normalized antenna gain elevation angle plot at φ=0°, in polar coordinates, which qualitatively represents the beamwidth of the antenna radiation pattern for the antenna of this invention in comparison to a structurally similar antenna without the passive radiating element;

FIG. 4B is a normalized antenna gain elevation angle plot at φ=90°, in polar coordinates, which qualitatively represents the beamwidth of the antenna radiation pattern for the antenna of this invention in comparison to a structurally similar antenna without the passive radiating element;

FIG. 4C is an absolute antenna gain elevation angle plot at φ=0°, in rectangular coordinates, which quantitatively represents gain and beamwidth for the antenna of this invention in comparison to a structurally similar antenna without the passive radiating element;

FIG. 4D is an absolute antenna gain elevation angle plot at φ=90°, in rectangular coordinates, which quantitatively represents the gain and beamwidth for the antenna of this invention in comparison to a structurally similar antenna without the passive radiating element; and

FIG. 5 is an electrical schematic illustrating power dividers electrically coupled with feeding elements.

### DETAILED DESCRIPTION OF THE INVENTION

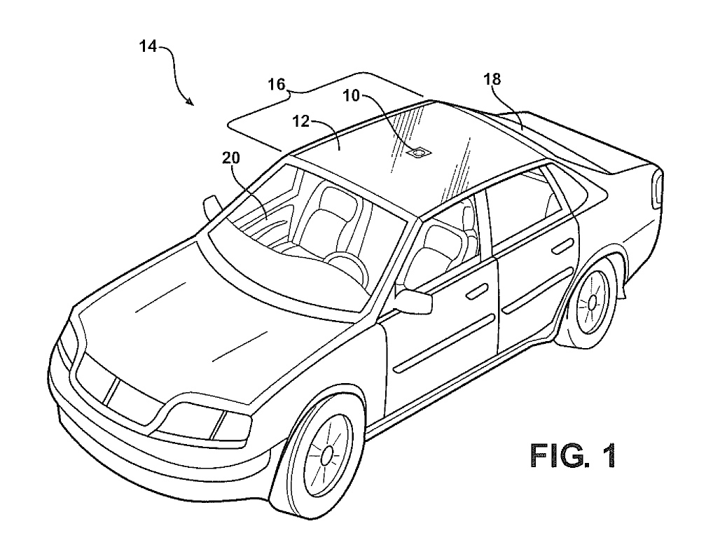

Referring to the Figures, wherein like numerals indicate like or corresponding parts throughout the several views, an antenna 10 is provided. As shown in FIG. 1, although not required, the antenna 10 is preferably integrated with a window 12 of a vehicle 14. The window 12 may be a roof window 16 (such as a glass roof), a rear window 18 (backlite), a front window 20 (windshield), or any other window of the vehicle 14 not integrated with the window 12. The antenna 10 of this invention may be located at other positions on the vehicle 14. The antenna 10 may also be implemented in other situations completely separate from the vehicle 14, such as on a building or integrated with a radio receiver.

The antenna 10 of this invention transmits and/or receives an RF signal. In a preferred embodiment, a particularly desired RF signal is a circularly polarized RF signal, and the antenna 10 is utilized for transmitting and/or receiving the circularly polarized RF signal from a satellite. The circularly polarized RF signal is described additionally below. The desired RF signal is typically produced by an SDARS provider, such as Sirius XM Radio, Inc. However, it is to be understood that the desired RF signal can be produced for other applications including, but not limited to, Global Positioning Systems (GPS), and the like. This desired RF signal is also described additionally below.

The window 12 having the antenna 10 integrated therein is a nonconductive pane 22. The nonconductive pane 22 is typically glass, such as soda lime silica glass. It is to be appreciated that the nonconductive pane 22 may be made from other materials including, but not limited to, plastic, fiberglass, and the like. The term nonconductive typically refers to a property of a material that, when placed between conductors at different potentials, permits only a small or negligible amount of current in phase with the applied voltage to flow through the material. Generally, the nonconductive pane 22 has an electrical conductivity on the order of nano siemens/meter.

Although not required, the window 12 may have more than one pane of glass. Those skilled in the art understand that the front window 20 of the vehicle 14 typically has several layers of the nonconductive pane 22 and contains an adhesive interlayer of polyvinyl butyral (PVB) sandwiched in between the nonconductive panes 22. Of course, the adhesive interlayer could be made of materials other than PVB. Another purpose for the nonconductive pane 22 in the context of this invention is to function as a radome for the antenna 10. As the radome, the nonconductive pane 22 protects the antenna 10 from dust, moisture, wind, etc. that are present outside the vehicle 14.

In its most basic form, the antenna 10 has a ground plane 24, a dielectric 26, an active radiating element 28, a feeding element 30, a passive radiating element 32, and at least one edge of the ground plane 24 extends as a curvilinear lip 34. In other embodiments, other components may be added to the antenna 10 to further improve the transmission and/or reception of the RF signal, especially at low elevation angles generally ranging from 10° to 30° and from 150° to 170°.

The ground plane 24 is made of an electrically conductive material including, but not limited to, copper, silver, aluminum, or the like. Preferably, the ground plane 24 is made of copper. The ground plane 24 is typically rectangular in shape, most typically square in shape. However, the ground plane 24 may be of any shape, including circular or another polygon configuration besides rectangular.

Although not required, the ground plane 24 typically has a length (L1) ranging from ¼ of a wavelength λ to 2 wavelengths λ of the RF signal, and a width (W) ranging from ¼ of a wavelength λ to 2 wavelengths λ of the RF signal. A desired RF signal transmitted by SDARS providers typically has a frequency from 2.32 GHz to 2.345 GHz. For example, Sirius XM Radio, Inc. broadcasts at a center frequency of 2.338 GHz, which corresponds to a wavelength λ, also commonly referred to as a ‘free space’ wavelength λ, of approximately 128 mm, according to the following equation Wavelength λ=Speed of Light (c)/Frequency. Therefore, the length (L1) and width (W) of the ground plane 24 typically range from about 32 mm to about 256 mm. In a preferred embodiment where the ground plane 24 is square in shape, the length (L1) and width (W) are each 80 mm. However, those skilled in the art realize alternative embodiments where the ground plane 24 defines alternative shapes and sizes based on a desired frequency and other considerations. The ground plane 24 has a plurality of edges with at least one of said edges extending as a curvilinear lip 34. Specifics surrounding the edges of the ground plane 24 and the curvilinear lip 34 are described additionally below.

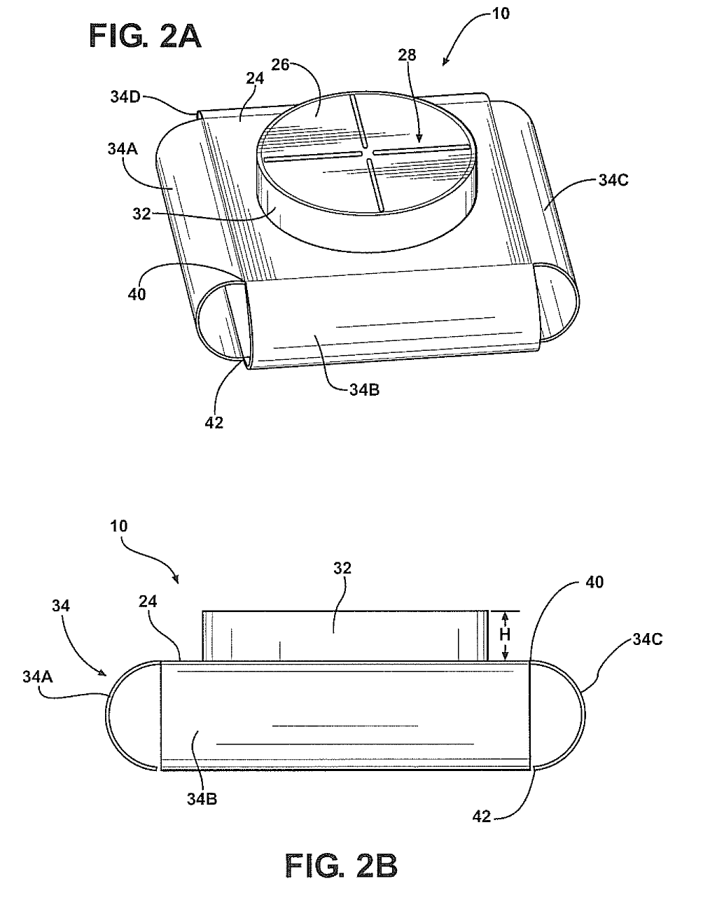

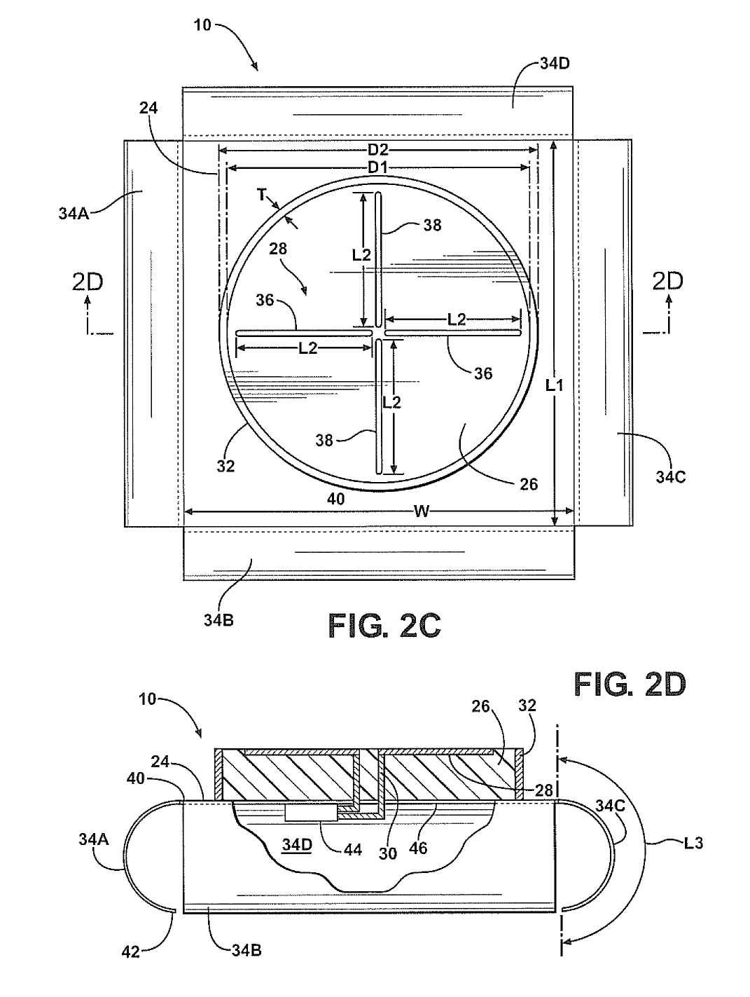

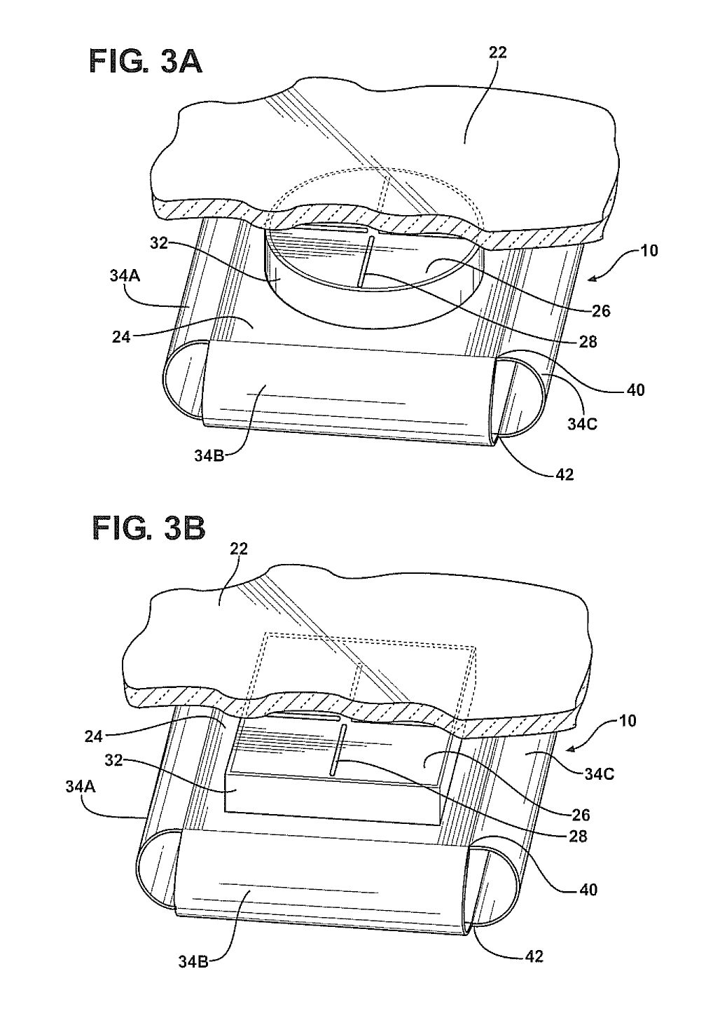

The dielectric 26 is disposed on the ground plane 24. Typically, the dielectric 26 is generally circular in shape. For example, referring to FIGS. 2C and 3A, the dielectric 26 is a cylinder having a circular cross section. However, the dielectric 26 may be of an alternative shape, such as illustrated in FIG. 3B, where the dielectric 26 is rectangular, more specifically square, in shape.

Although not required, the dielectric 26 typically has a diameter (D1) ranging from ¼ of an equivalent wavelength λ to 2 equivalent wavelengths λ of the RF signal, and a height ranging from 1/16 of an equivalent wavelength λ to ½ of an equivalent wavelength λ of the RF signal. The diameter (D1) of the dielectric 26 is illustrated in FIG. 2C. Alternatively, the dielectric 26 may be of different shapes and sizes based on the desired frequency and other considerations. In the preferred embodiment, the dielectric 26 has a diameter (D1) of approximately 45 mm and a height of approximately 8 mm. In general, the dielectric 26 serves as a support structure for the active radiating element 28. The shape and size of the dielectric 26 also enables the shape and size of the active radiating element 28, described immediately below, to be reduced. Notably, in the context of the possible dimensions described above for the dielectric 26, the term equivalent wavelength λ, as opposed to the term wavelength λ is utilized. It is to be known by those skilled in the art that equivalent wavelength can be determined knowing wavelength λ and a relative permittivity of the dielectric 26 according to the following equation: Equivalent wavelength λ=Wavelength λ/(Relative Permittivity of the dielectric 26)^{1/2}. The equivalent wavelength λ is also applicable to the determination of dimensions surrounding the active and passive radiating elements 28, 32 as described below. The dielectric 26 typically has a relative permittivity ranging from 1 to 100. As is understood by those skilled in the art, the relative permittivity is a value that represents the ability to transmit an electric field through the dielectric 26. In the preferred embodiment, the relative permittivity of 3.4 is desired.

The active radiating element 28 is embedded in the dielectric 26 and transmits and/or receives the RF signal. The active radiating element 28 can be completely or partially embedded in the dielectric 26. If the antenna 10 of this invention is utilized in the window 12 in conjunction with the nonconductive pane 22, then the active radiating element 28 may be in contact with the nonconductive pane 22. However, contact between the active radiating element 28 and the nonconductive pane 22 is not required. The active radiating element 28 is active in that it is in direct connection with the feeding element 30. As described below, the feeding element 30 directly excites the active radiating element 28.

The active radiating element 28 is dimensioned to correspond to the frequency or frequencies for which it is desirous to transmit and/or receive the RF signal. As indicated below, it is preferred that the active radiating element 28 is in a cross dipole configuration for the purposes of transmitting and/or receiving RF signals which are circularly polarized. However, it is to be understood that in the antenna 10 of this invention, there is no requirement that there be more than one active radiating element 28, or even where there is more than one active radiating element 28, there is no requirement that the active radiating elements 28 only be in a cross dipole configuration. In alternative embodiments, a patch-type element may be implemented as the active radiating element 28.

The active radiating element 28 typically has a length (L2), as illustrated in FIG. 2C, ranging from 1/16 of an equivalent wavelength λ to ½ of an equivalent wavelength of the RF signal. In one preferred embodiment, the active radiating element 28 has a length (L2) of 16 mm. However, it is to be understood by those ordinarily skilled in the art that additional embodiments exist where the active radiating element 28 is sized and shaped differently to accommodate alternative frequency requirements as well as other performance requirements.

The active radiating element 28 may be further defined as a plurality of active radiating elements 28 embedded in the dielectric 26, i.e., there can be more than one active radiating element 28. Where there is a plurality of active radiating elements 28, the active radiating elements 28 are most typically parallel to the ground plane 24, although absolute parallelism is not required. As particularly illustrated in FIGS. 2A, 2C, 2D, 3A, and 3B, the plurality of active radiating elements 28 may be implemented as a cross dipole configuration having a first dipole 36 and a second dipole 38. Each dipole 36, 38 includes a pair of radiating elements 28. The first and second dipoles 36, 38 transmit and/or receive at least one first dipole signal and at least one second dipole signal, respectively. The first and second dipole signals have equal magnitudes and a relative phase difference of 90°, i.e., the first and second dipole signals are orthogonally polarized relative to one another. As such, the active radiating element 28, in this cross dipole configuration, is ideal for transmitting and/or receiving circularly polarized RF signals.

Referring now to FIG. 2D, feeding element 30 extends into the dielectric 26. The feeding element 30 is electrically coupled to the active radiating element 28. This electrical coupling may be accomplished mechanically, electromechanically, or electromagnetically. In the preferred embodiment, the feeding element 30 is coupled to the active radiating element 28 electromechanically, where there is a direct, physical connection between the feeding element 30 and the active radiating element 28 by soldering. Soldering requires that the feeding element 30 be formed of an electrically conductive material including, but not limited to, silver, copper, or the like. The feeding element 30 is typically oriented perpendicular to the ground plane 24.

Although not required, the antenna 10 can include more than one feeding element 30, where the feeding element 30 is further defined as a plurality of feeding elements 30. If there is a plurality of feeding elements 30, it is preferred that the feeding elements 30 are perpendicular to the ground plane 24. A plurality of feeding elements 30 may be implemented, for example, when the active radiating element 28 is implemented in the cross dipole configuration with the first and second dipoles 36, 38. In such an example, first and second feeding elements of the plurality of feeding elements 30 are coupled to the first dipole 36, and third and fourth feeding elements of the plurality of feeding elements 30 are coupled to the second dipole 38. The feeding elements 30 and the active radiating elements 28 are electrically isolated from the ground plane 24.

The passive radiating element 32 is disposed on the ground plane 24 and surrounds a periphery of the dielectric 26 for perturbating the RF signal. The passive radiating element 32 is passive in that it is not connected to the feeding element 30. Instead, the passive radiating element 32 is excited by induction. Although not required, as illustrated throughout the Figures, the passive radiating element 32 actually contacts the dielectric 26 as the passive radiating element 32 surrounds the periphery of the dielectric 26. However, it is to be appreciated that the passive radiant element 32 can surround the periphery of the dielectric 26 without direct contact with the dielectric 26. The shape of the passive radiating element 32 is driven primarily by the shape of the dielectric 26. In the preferred embodiment, the passive radiating element 32 is a ring surrounding the periphery of the dielectric 26 which is generally circular in shape. However, it is to be appreciated that other shapes or configurations for the passive radiating element 32 may be implemented, such as the passive radiating element 32 which is rectangular, or even square, in shape as in FIG. 3B.

Although not required, the passive radiating element 32 typically has a diameter (D2) ranging from ¼ of an equivalent wavelength λ to 2 equivalent wavelengths λ of the RF signal, and a thickness (T) ranging from 1/64 of an equivalent wavelength λ to 1 equivalent wavelength λ of the RF signal. The diameter (D2) and thickness (T) of the passive radiating element 32 are illustrated in FIG. 2C. Preferably, a height (H) of the passive radiating element 32 is equal to or less than a height of the active radiating element 28, such as the first 36 and second 38 dipoles, as particularly illustrated in FIGS. 2C and 2D. In FIG. 2D, the height (H) of the passive radiating element 32 is equal to the height of the first and second dipoles 36, 38. In a situation where the height (H) of the passive radiating element 32 is less than the height of the active radiating element 28, and where the antenna 10 is implemented with the nonconductive pane 22, it is possible that the passive radiating element 32 does not contact the nonconductive pane 22. Here, the active radiating element 28 and/or portions of the dielectric 26 are in contact with the nonconductive pane 22, but the passive radiating element 32 is not. The passive radiating element 32 which, as described above, perturbates the RF signal, acts in conjunction with the ground plane 24 to further improve a beamwidth of an antenna radiation pattern for the antenna 10 of this invention, which is described additionally below. The passive radiating element 32 creates a perturbation which interferes with the RF signal. The passive radiating element 32, by means of a desired diffraction effect, alters a magnitude and a phase of the transmitted and/or received RF signal causing an overall improvement of the transmitted and/or received RF signal. This desired diffraction effect is particularly beneficial when satellites are at low elevation angles generally ranging from 10° to 30° and from 150° to 170°.

The ground plane 24 has a plurality of edges and, as indicated above, at least one edge of the ground plane 24 extends as the curvilinear lip 34. The at least one edge of the ground plane 24 extends as the curvilinear lip 34 in a direction opposite the passive radiating element 32 for directing the RF signal and for preventing abrupt discontinuity of the RF signal. Ideally, the curvilinear lip 34 prevents abrupt discontinuity; however, it is to be understood that the terminology preventing, when used in this context, also includes any effect the curvilinear lip 34 may have on minimizing, as opposed to completely preventing, abrupt discontinuity of the RF signal.

The curvilinear lip 34 is curved and is preferably semi-circular in shape as particularly illustrated throughout the Figures. However, the curvilinear lip 34 of this invention can be curvilinear, or curved, in other fashions without being precisely semi-circular in shape.

As also indicated above, the ground plane 24 may be of any shape. Any number of the edges of the ground plane 24 can extend as a curvilinear lip 34 so long as at least one of the edges of the ground plane 24 extends as the curvilinear lip 34. In the most preferred embodiment, the ground plane 24 is rectangular in shape. Obviously, with a ground plane 24 that is rectangular in shape, there are four edges. Here, it is most preferred that each of these four edges extends as curvilinear lips 34A, 34B, 34C, and 34D, as particularly illustrated in FIG. 2A. However, in alternative embodiments, there is no requirement that four edges of the ground plane 24 extend as a curvilinear lip 34. For example, only one, two, or three edges of the ground plane 24 may extend as a curvilinear lip 34. In other embodiments, at least three of the edges of the ground plane 24 each extend as a curvilinear lip 34 for directing the RF signal and for preventing abrupt discontinuity of the RF signal. In still other embodiments, the ground plane 24 is another polygon configuration having, for example, more than four edges where at least four of the edges of the ground plane 24 each extend as a curvilinear lip 34 for reflecting the RF signal.

Referring, in particular, to FIG. 2D, the curvilinear lip 34 has a proximal end 40 and a distal end 42, and a length (L3) extending from the proximal end 40 to the distal end 42, as illustrated in FIG. 2D. Although not required, the length (L3) of the curvilinear lip 34 typically measures from ¼ of a wavelength λ to 2 equivalent wavelengths λ of the RF signal. It is to be understood that the length (L3) of the curvilinear lip 34 set forth above is a length which extends along a surface of the curvilinear lip 34, and not a length which extends directly between the proximal and distal ends 40, 42.

The RF signal follows the curvilinear lip 34 of the ground plane 24 thereby preventing abrupt discontinuity of the RF signal and reducing undesired diffraction effects which would, ultimately, have an impact on the beamwidth of the antenna radiation pattern of this antenna 10, especially at the low elevation angles generally ranging from 10° to 30° and from 150° to 170°. The curvilinear lip 34 operates in conjunction with the other components of this antenna 10, especially the passive radiating element 32 in its location surrounding the periphery of the dielectric 26, to improve the performance of the antenna 10, specifically by increasing the beamwidth for improved reception of the satellite signals at the low elevation angles.

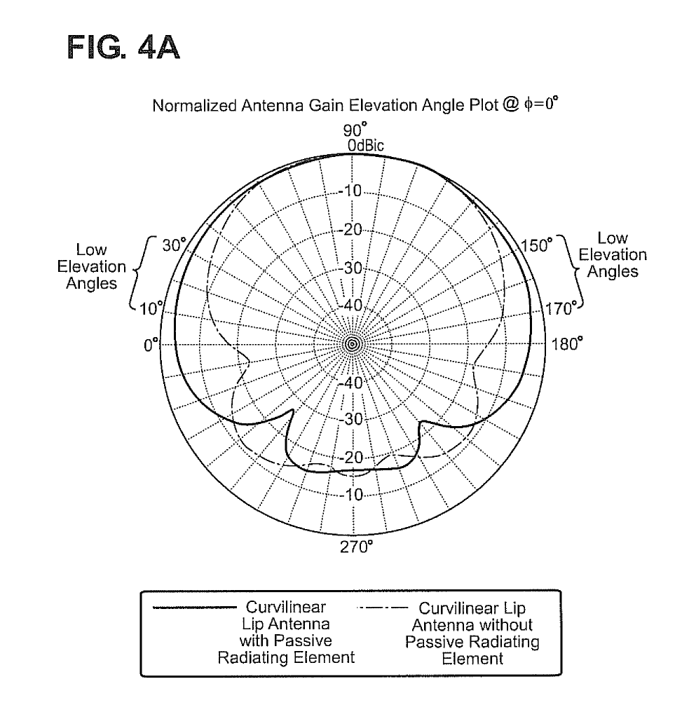

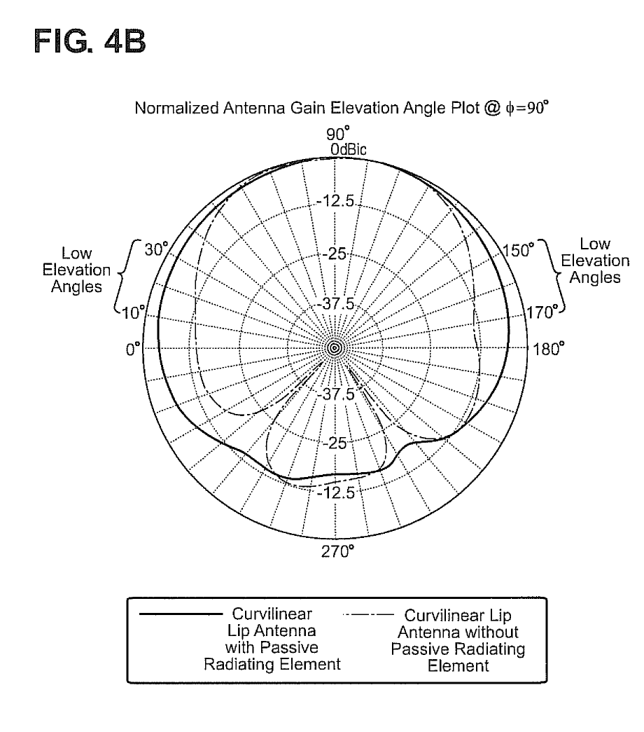

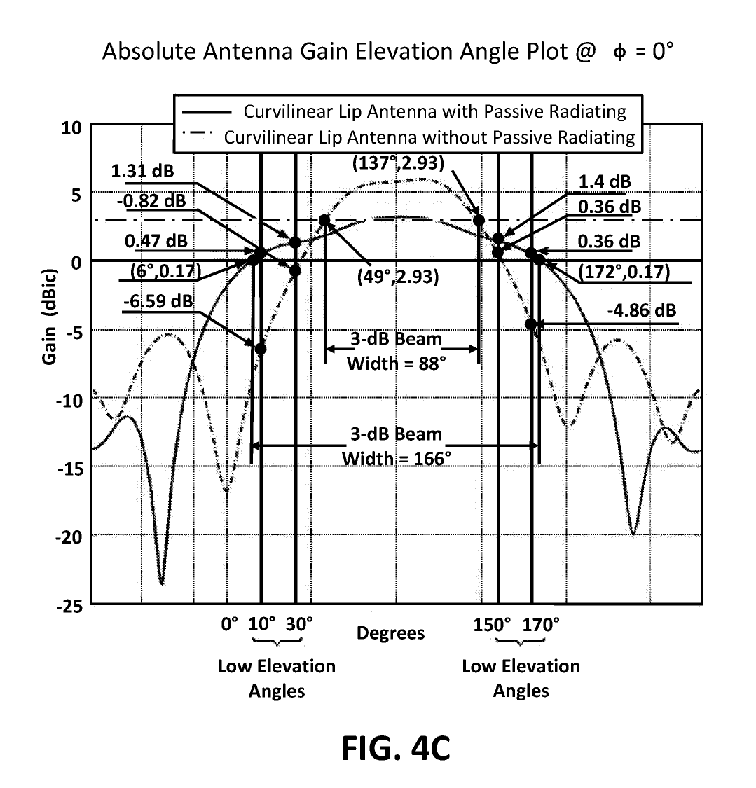

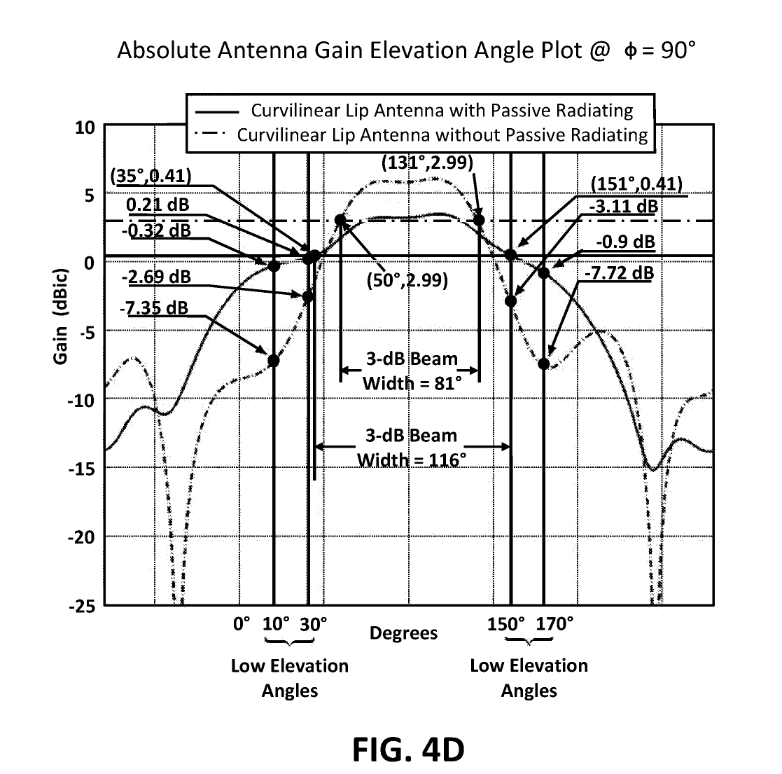

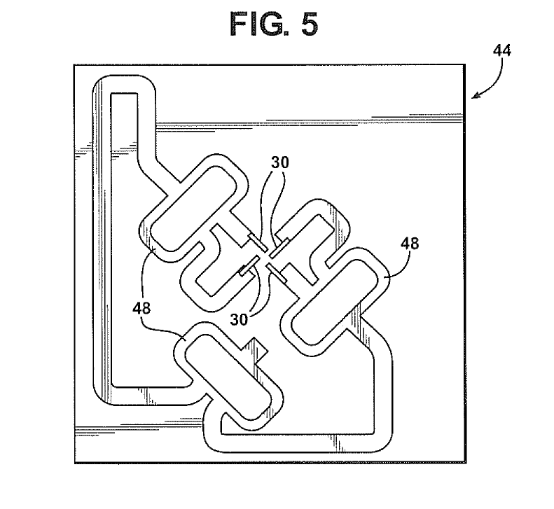

As indicated above, the antenna 10 improves the transmitting and/or receiving of the RF signal, particularly the circularly polarized RF signal, by increasing the beamwidth of the antenna radiation pattern. The beamwidth of the antenna radiation pattern for the antenna 10 of this invention is both qualitatively and quantitatively represented in the antenna gain elevation angle plots of FIGS. 4A-4D. FIGS. 4A-4D also illustrate, by comparison, improvements in the antenna 10 of this invention over a structurally similar antenna without the passive radiating element 32. The comparative antenna referred to in FIGS. 4A-4D does not have a passive radiating element, but is otherwise identical to the antenna 10 of this invention in structure, size, orientation, number and type of components, etc. In FIGS. 4A-4D, the antenna 10 of this invention is represented be a solid line, and the structurally similar antenna without the passive radiating element 32 is represented by a dotted line.

FIGS. 4A and 4B, which are referred to additionally below, are normalized antenna gain elevation angle plots in polar coordinates primarily for qualitative representation of the beamwidth of the antenna radiation pattern for the antenna 10 of this invention. FIGS. 4C and 4D, which are also referred to additionally below, are absolute antenna gain elevation angle plots in rectangular coordinates primarily for quantitative representation of certain properties of the antenna 10, gain and beamwidth. The frequency of the RF signal used for the testing represented in FIGS. 4A-4D is about 2.3 GHz. Of course, the beamwidth of the antenna radiation pattern can be evaluated at other frequencies as appreciated by those skilled in the art.

As indicated above, FIGS. 4A and 4B are normalized antenna gain elevation angle plots in polar coordinates. Phi (φ), which is the azimuth angle, =0° in FIG. 4A. The normalized antenna gain elevation angle plot of FIG. 4A illustrates one cut of the antenna radiation pattern at a particular azimuth angle, which is 0° in FIG. 4A. Phi (φ)=90° in FIG. 4B. The normalized antenna gain elevation angle plot of FIG. 4B illustrates one cut of the antenna radiation pattern at a particular azimuth angle, which is 90° in FIG. 4B. It is to be understood that antenna radiation patterns may not be symmetrical in shape. As such, reliance on different azimuth angles, represented by different Phi (φ), may also be helpful in further understanding the beamwidth of the antenna radiation pattern of the antenna 10.

The normalized antenna gain elevation angle plots in FIGS. 4A and 4B illustrate improvements in the beamwidth of the antenna radiation pattern for this antenna 10 when compared to the structurally similar antenna without the passive radiating element 32. As illustrated in both FIGS. 4A and 4B, the beamwidth for the antenna 10 is generally increased and is especially increased at the low elevation angles from 10° to 30° and from 150° to 170°. This increase can be appreciated by a greater normalized gain for the antenna 10, i.e., an antenna with the particular passive radiating element 32 of this invention which surrounds a periphery of the dielectric 26, particularly at the low elevation angles. When viewing the normalized antenna gain elevation angle plots in FIGS. 4A and 4B, it is beneficial to theoretically position the ground plane 24 of this antenna 10 parallel with a line extending between 0° and 180° on the antenna gain normalized elevation angle plots. As such, the low elevation angle of 10°, which is referred to throughout this description, is represented at both 10° and 170° on the normalized antenna gain elevation angle plots. Likewise, the low elevation angle of 30° is represented at both 30° and 150° on the normalized antenna gain elevation angle plots.

As indicated above, FIGS. 4C and 4D are absolute antenna gain elevation angle plots in rectangular coordinates. Phi (φ)=0° in FIG. 4C, and phi (φ)=90° in FIG. 4D. The absolute antenna gain elevation angle plots in FIGS. 4C and 4D are particularly useful for quantitatively appreciating the gain and beamwidth of the antenna 10.

Specifically, as particularly illustrated in FIGS. 4C and 4D, the gain of the antenna 10 is increased, especially at the low elevation angles from 10° to 30° and from 150° to 170°, as compared to the structurally similar antenna without the passive radiating element 32 at phi (φ)=0° and phi (φ)=90°. At the frequency of about 2.3 GHz, the gain of the antenna 10 is always greater than −0.9 dB at the low elevation angles from 10° to 30° and 150° to 170°. This is not the case for the structurally similar antenna without the passive radiating element 32, i.e., the gain of the comparative antenna is not always greater than −0.9 dB at elevation angles from 10° to 30° and 150° to 170°. More specifically, with reference to FIG. 4C, the gain of the antenna 10 increases by at least 7.06 dB over the comparative antenna (increasing from −6.59 dB to 0.47 dB) at the low elevation angle of 10°. At the low elevation angle of 30°, the gain of the antenna 10 increases by at least 2.13 dB over the comparative antenna (increasing from −0.82 dB to 1.31 dB). Again, with reference to FIG. 4C, the gain of the antenna 10 increases by at least 1.04 dB over the comparative antenna (increasing from 0.36 dB to 1.40 dB) at the low elevation angle of 150°. At the low elevation angle of 170°, the gain of the antenna 10 increases by at least 5.22 dB over the comparative antenna (increasing from −4.86 dB to 0.36 dB). With reference to FIG. 4D, the gain of the antenna 10 increases by at least 7.03 dB over the comparative antenna (increasing from −7.35 dB to −0.32 dB) at the low elevation angle of 10°. At the low elevation angle of 30°, the gain of the antenna 10 increases by at least 2.9 dB over the comparative antenna (increasing from −2.69 dB to 0.21 dB). Again, with reference to FIG. 4D, the gain of the antenna 10 increases by at least 3.52 dB over the comparative antenna (increasing from −3.11 dB to 0.41 dB) at the low elevation angle of 150°. At the low elevation angle of 170°, the gain of the antenna 10 increases by at least 6.82 dB over the comparative antenna (increasing from −7.72 dB to −0.90 dB). Notably, an increase in the gain of the antenna 10 can be appreciated at other low elevation angles generally from 10° to 30° and 150° to 170° as compared to the comparative antenna.

As illustrated in FIG. 4C, a standard 3-dB beamwidth is used for determining the beamwidth of an antenna radiation pattern and is known in the art and referred to throughout industry as “3-dB beamwidth”. The 3-dB beamwidth of the antenna radiation pattern of the antenna 10 is 166° at the frequency of about 2.3 GHz and, as illustrated in FIG. 4D, the 3-dB beamwidth of the antenna radiation pattern of the antenna 10 is 116° at the frequency of about 2.3 GHz, such that at both phi (φ)=0° and phi (φ)=90°, the 3-dB beamwidth of the antenna 10 is always greater than 88°, which is the 3-dB beamwidth of the structurally similar antenna without the passive radiating element 32, i.e., of the comparative antenna. More specifically, with reference to FIG. 4C, the 3-dB beamwidth of the antenna radiation pattern of the antenna 10 is 166°, whereas the 3-dB beamwidth of the antenna radiation pattern of the comparative antenna is only 88°. Directly comparing the 3-dB beamwidth for the antenna 10 of this invention, which is 166°, to the 3-dB beamwidth for the comparative antenna, which is 88°, indicates a 78° improvement in beamwidth in FIG. 4C. With reference to FIG. 4D, the 3-dB beamwidth of the antenna radiation pattern of the antenna 10 is 116°, whereas the 3-dB beamwidth of the antenna radiation pattern of the comparative antenna is only 81°. Directly comparing the 3-dB beamwidth for the antenna 10 of this invention, which is 116° to the 3-dB beamwidth for the comparative antenna, which is 81°, indicates a 35° improvement in beamwidth in FIG. 4D.

Finally, with reference to FIGS. 2D and 5, a power dividing circuit 44 is disclosed. Although not required for the antenna 10 of this invention, the power dividing circuit 44 is a preferred component of the antenna 10. If utilized, the power dividing circuit 44 is typically coupled to the feeding element 30 and mounted to an underside 46 of the ground plane 24 opposite the dielectric 26 and the passive radiating element 32.

FIG. 2D illustrates a cross sectional view of FIG. 2C where a portion of the curvilinear lip 34 is cut away from the antenna 10. As such, the power dividing circuit 44 is partially exposed in FIG. 2D. With reference to this Figure, the power dividing circuit 44 is mounted on the underside 46 of the ground plane 24 opposite the dielectric 26 and the passive radiating element 32.

The power dividing circuit 44 has a power divider 48. The power divider 48 is coupled to the feeding element 30 or feeding elements 30 by soldering or the like. It is to be understood that other forms of coupling are possible. Preferably, the power dividing circuit 44 has a plurality of power dividers 48, more preferably three power dividers 48. As illustrated in FIG. 5, three power dividers 48 are electromechanically coupled to the four feeding elements 30.

The power dividing circuit 44 balances the impedance of the plurality of feeding elements 30. This balancing improves transfer of power and prevents crosstalk. The power dividing circuit 44 also introduces the proper relative phase difference and magnitude between the first and second dipoles 36, 38 to transmit and/or receive the circularly polarized RF signal, where the active radiating element 28 is implemented in the cross dipole configuration with the first and second dipoles 36, 38.

It is to be understood that the terminology which has been used herein is intended to be in the nature of words of description rather than of limitation. Obviously, many modifications and variations of the present invention are possible in light of the above description and teachings. The invention may be practiced otherwise than as specifically described within the scope of the appended claims. Additionally, although the Figures are not necessarily to scale, it is be understood that the Figures do accurately represent relative ratios in the size and dimensions between the various discrete components of the antenna 10 of this invention.

What is claimed is:

1. An antenna comprising:
a ground plane;
a dielectric disposed on said ground plane;
an active radiating element embedded in said dielectric for transmitting and/or receiving an RF signal;
a feeding element extending into said dielectric and electrically coupled to said active radiating element; and
a passive radiating element disposed on said ground plane and surrounding a periphery of said dielectric for perturbating the RF signal;
wherein said ground plane has a plurality of edges with at least one of said edges extending as a curvilinear lip in a direction opposite said passive radiating element for directing the RF signal and for preventing abrupt discontinuity of the RF signal.

2. An antenna as set forth in claim 1 wherein at least three of said edges of said ground plane each extend as a curvilinear lip for directing the RF signal and for preventing abrupt discontinuity of the RF signal.

3. An antenna as set forth in claim 1 wherein at least four of said edges of said ground plane each extend as a curvilinear lip for directing the RF signal and for preventing abrupt discontinuity of the RF signal.

4. An antenna as set forth in claim 1 wherein said curvilinear lip is semi-circular in shape.

5. An antenna as set forth in claim 1 wherein said curvilinear lip has a proximal end and a distal end, and a length extending from said proximal end to said distal end, with said length of said curvilinear lip measuring from ¼ of an equivalent wavelength λ to 2 equivalent wavelengths λ of the RF signal.

6. An antenna as set forth in claim 1 wherein said active radiating element is further defined as a plurality of active radiating elements embedded in said dielectric and arranged in a cross dipole configuration having a first dipole and a second dipole, wherein said first and second dipoles transmit and/or receive at least one first dipole signal and at least one second dipole signal, respectively, having equal magnitudes and a relative phase difference of 90°.

7. An antenna as set forth in claim 6 wherein said feeding element is further defined as a plurality of feeding elements, with a first and a second feeding element of said plurality of feeding elements coupled to said first dipole, and a third and a fourth feeding element of said plurality of feeding elements coupled to said second dipole.

8. An antenna as set forth in claim 1 wherein said dielectric is generally circular in shape and said passive radiating element is a ring which surrounds said periphery of said circular dielectric.

9. An antenna as set forth in claim 8 wherein said dielectric has a diameter ranging from ¼ of an equivalent wavelength λ to 2 equivalent wavelengths λ of the RF signal, a height ranging from 1/16 of an equivalent wavelength λ to ½ an equivalent wavelength λ of the RF signal, and a relative permittivity ranging from 1 to 100.

10. An antenna as set forth in claim 8 wherein said passive radiating element has a diameter ranging from ¼ of an equivalent wavelength λ to 2 equivalent wavelengths λ of the RF signal, and a thickness ranging from 1/64 of an equivalent wavelength λ to 1 equivalent wavelength λ of the RF signal.

11. An antenna as set forth in claim 1 wherein said ground plane is rectangular in shape and each of said four edges extend as a curvilinear lip.

12. An antenna as set forth in claim 1 wherein said ground plane has a length ranging from ¼ of an equivalent wavelength λ to 2 equivalent wavelengths λ of the RF signal, and a width ranging from ¼ of an equivalent wavelength λ to 2 equivalent wavelengths λ of the RF signal.

13. An antenna as set forth in claim 6 wherein a height of said passive radiating element is equal to or less than a height of said first and second dipoles.

14. An antenna as set forth in claim 1 further comprising a power dividing circuit coupled to said feeding element and mounted to an underside of said ground plane opposite said dielectric and said passive radiating element.

15. An antenna as set forth in claim 6 wherein said plurality of active radiating elements are parallel to said ground plane.

16. An antenna as set forth in claim 7 wherein said plurality of feeding elements are perpendicular to said ground plane.

17. An antenna as set forth in claim 1 wherein, at a frequency of about 2.3 GHz, a gain of said antenna is always greater than −0.90 dB at low elevation angles from 10° to 30° and 150° to 170°.

18. An antenna as set forth in claim 1 wherein, at a frequency of about 2.3 GHz and at a standard 3-dB beamwidth of the antenna radiation pattern, a beamwidth of an antenna radiation pattern of said antenna is greater than 88°.

19. A window having an integrated antenna, said window comprising:
a nonconductive pane;
a ground plane spaced from said nonconductive pane;
a dielectric sandwiched between said ground plane and said nonconductive pane;
an active radiating element embedded in said dielectric for transmitting and/or receiving an RF signal;
a feeding element extending into said dielectric and electrically connected to said active radiating element; and
a passive radiating element sandwiched between said ground plane and said nonconductive pane, said passive radiating element surrounding a periphery of said dielectric for perturbating the RF signal;
wherein said ground plane has a plurality of edges with at least one of said edges extending as a curvilinear lip in a direction opposite said passive radiating element for directing the RF signal and for preventing abrupt discontinuity of the RF signal.

20. A window set forth in claim 19 wherein said nonconductive pane is glass.

21. A window set forth in claim 19 wherein at least four of said edges of said ground plane each extend as a curvilinear lip for directing the RF signal and for preventing abrupt discontinuity of the RF signal.

22. A window set forth in claim 19 wherein said curvilinear lip is semi-circular in shape.

23. A window set forth in claim 19 wherein said active radiating element is further defined as a plurality of active radiating elements embedded in said dielectric and arranged in a cross dipole configuration having a first dipole and a second dipole, wherein said first ands second dipoles transmit and/or receive at least one first dipole signal and at least one second dipole signal, respectively, having equal magnitudes and a relative phase difference of 90°.

24. A window set forth in claim 23 wherein said feeding element is further defined as a plurality of feeding elements, with a first and a second feeding element of said plurality of feeding elements coupled to said first dipole, and a third and a fourth feeding element of said plurality of feeding elements coupled to said second dipole.

25. A window set forth in claim 19 wherein said dielectric is generally circular in shape and said passive radiating element is a ring which surrounds said periphery of said circular dielectric.

26. A window set forth in claim 25 wherein said dielectric has a diameter ranging from ¼ of an equivalent wavelength λ to 2 equivalent wavelengths λ of the RF signal, a height ranging from 1/16 of an equivalent wavelength λ to ½ of an equivalent wavelength λ of the RF signal, and a relative permittivity ranging from 1 to 100; and said passive radiating element has a diameter ranging from ¼ of an equivalent wavelength to 2 equivalent wavelengths λ of the RF signal, and a thickness ranging from 1/64 of an equivalent wavelength λ to 1 equivalent wavelength λ of the RF signal.

27. A window set forth in claim 19 wherein said ground plane is rectangular in shape and each of said four edges extend as a curvilinear lip

28. A window set forth in claim 23 wherein a height of said passive radiating element is equal to or less than a height of said first and second dipoles.

29. An antenna as set forth in claim 19 wherein, at a frequency of about 2.3 GHz, a gain of said antenna is always greater than −0.90 dB at low elevation angles from 10° to 30° and 150° to 170°.

30. An antenna as set forth in claim 19 wherein, at a frequency of about 2.3 GHz and at a standard 3-dB beamwidth of the antenna radiation pattern, a beamwidth of an antenna radiation pattern of said antenna is greater than 88°.
